(19) United States
(12) Patent Application Publication
(10) Pub. No.: US 2018/0159194 A1
(43) Pub. Date: Jun. 7, 2018

(54) COUPLING WINDOW, DIELECTRIC WAVEGUIDE FILTER, AND RESONATOR ASSEMBLY

(71) Applicant: Murata Manufacturing Co., Ltd., Kyoto (JP)

(72) Inventor: Yukikazu YATABE, Saitama (JP)

(21) Appl. No.: 15/886,222

(22) Filed: Feb. 1, 2018

Related U.S. Application Data
(63) Continuation of application No. PCT/JP2016/085268, filed on Nov. 29, 2016.

(30) Foreign Application Priority Data
Jan. 15, 2016 (JP) 2016-005811

(51) Int. Cl. H01P 5/02; H01P 1/20

(52) U.S. Cl. CPC H01P 5/02; H01P 1/2002

(57) ABSTRACT

A coupling window is provided that couples two dielectric waveguide resonators, each resonator having a resonant mode of TE mode and being a rectangular parallelepiped dielectric body whose outer surface is coated with a conducting film. The coupling window includes a first linear portion and a second linear portion extending from an end portion of the first linear portion. The first linear portion extends parallel to a first direction and the second linear portion extends parallel to a second direction orthogonal to the first direction. The coupling window further includes a third linear portion extending from an end portion of the second linear portion. The third linear portion extends parallel to the first direction.

This is a continuation of International Application No. PCT/JP2016/085268 filed on Nov. 29, 2016 which claims priority from Japanese Patent Application No. 2016-005811 filed on Jan. 15, 2016. The contents of these applications are incorporated herein by reference in their entireties.

### BACKGROUND

### 1. Technical Field

The present disclosure relates to coupling windows for coupling dielectric waveguide resonators, each resonator being a rectangular parallelepiped dielectric block outside of which is coated with a conducting film. The present disclosure further relates to dielectric waveguide filters using such coupling windows.

### 2. Description of Related Art

A dielectric waveguide filter or the like uses a plurality of dielectric waveguide resonators that are coupled.

When coupling TE-mode dielectric waveguide resonators formed by coating the outside of a rectangular parallelepiped dielectric body with a conducting film, a coupling window exposing the dielectric body is formed on each dielectric waveguide resonator at a side facing the other dielectric waveguide resonator to be coupled. Hereinafter, the length of the coupling window in an electric field direction is referred to as the height of the coupling window, and the length of the coupling window in a magnetic field direction orthogonal to the electric field direction is referred to as the width of the window.

The coupling window generally establishes an inductive coupling when the height of window is made larger compared with the width of window, and generally establishes a capacitive coupling when the height of window is made smaller compared with the width of window.

### SUMMARY

FIG. 11 is an exploded transparent perspective view illustrating a case where dielectric waveguide resonators are coupled using coupling windows in related art. The dielectric waveguide resonators 1 and 2 each have a resonant mode of TE101 and a rectangular parallelepiped shape whose outer dimensions are A in width, L in length, and H in height. The resonators 1, 2 are aligned along a length L direction and are coupled by capacitive coupling windows 4, each of which has a height h and a width w and is formed at a center of a connecting face 3.

FIG. 12 illustrates the variation in coupling coefficient k when the width A=3.4 mm, the length L=3.8 mm, the height H=1.5 mm, the height h=0.1 mm, and the width w of the coupling window is varied.

In FIG. 12, the vertical axis represents the coupling coefficient k, and the horizontal axis represents the width w (mm) of the coupling window.

FIG. 13 is a graph illustrating the variation in coupling coefficient k when the width A=3.4 mm, the length L=3.8 mm, the height H=1.5 mm, the width w=3.4 mm, and the height h of the coupling window is varied. In FIG. 13, the vertical axis represents the coupling coefficient k, and the horizontal axis represents the height h (mm) of the coupling window.

According to the results of FIG. 12 and FIG. 13, the height of the coupling window needs to be reduced or the width of the coupling window needs to be widened in order to reduce the coupling coefficient of the coupling window.

In FIG. 12 and FIG. 13, the coupling coefficient k is in the range approximately from 0.1 to 0.15. However, these values are too large for designing typical dielectric waveguide filters. Thus, it is desirable to reduce the coupling coefficient by widening the width of the coupling window or by reducing the height of the coupling window.

However, there are issues in that the width w of the coupling window can be widened only up to the width A of the resonator, and a decrease in height h of the coupling window causes degradation of power resistance characteristic and necessitates an excessive precision in fabrication.

As a method for resolving the foregoing issues, there is proposed a method of interposing a dielectric plate having high dielectric constant between side faces to be connected, as described in Japanese Unexamined Patent Application Publication No. 2012-191474. However, in this method, there is an issue of increasing loss due to the dielectric plate.

Thus, with coupling windows of dielectric waveguide resonators in related art, it is difficult to have high power resistance characteristic and capacitive coupling with small coupling coefficient.

An object of the present disclosure is to provide a coupling window of dielectric waveguide resonator having a higher power resistance characteristic and enabling capacitive coupling with a smaller coupling coefficient, and to provide a dielectric waveguide filter having such coupling window.

A coupling window of dielectric waveguide resonator according to the present disclosure is a coupling window for coupling two dielectric waveguide resonators, each resonator resonating at TE mode and including a rectangular parallelepiped dielectric body with a conducting film coating an outer surface of the rectangular parallelepiped dielectric body. The coupling window includes a first linear portion extending parallel to a first direction, a second linear portion extending from an end portion of the first linear portion, the second linear portion extending parallel to a second direction that is orthogonal to the first direction, and a third linear portion extending from an end portion of the second linear portion, the third linear portion extending parallel to the first direction.

According to the present disclosure, there is provided a coupling window of dielectric waveguide resonator having a higher power resistance characteristic and enabling capacitive coupling with a smaller coupling coefficient.

Further, by using a coupling window of dielectric waveguide resonator according to the present disclosure in a dielectric waveguide filter using jump coupling, a dielectric waveguide filter having a higher power resistance characteristic can be provided.

### BRIEF DESCRIPTION OF THE DRAWINGS

FIG. 1 is an exploded transparent perspective view for describing a coupling window of a dielectric waveguide resonator according to a first embodiment of the present disclosure.

FIG. 2 is a plan view of the coupling window of the dielectric waveguide resonator illustrated in FIG. 1.

FIG. 3 is a graph illustrating the result of electromagnetic simulation on the dielectric waveguide resonator illustrated in FIG. 1.

FIG. 4 is a plan view of a coupling window of the dielectric waveguide resonator according to a second embodiment of the present disclosure.

FIG. 5 is a graph illustrating the result of electromagnetic simulation on the dielectric waveguide resonator illustrated in FIG. 4.

FIG. 6 is a plan view of a coupling window of the dielectric waveguide resonator according to a third embodiment of the present disclosure.

FIG. 7 is a graph illustrating the result of electromagnetic simulation on the dielectric waveguide resonator illustrated in FIG. 6.

FIG. 8 is an exploded transparent perspective view of a dielectric waveguide filter according to a fourth embodiment of the present disclosure.

FIG. 9 is a schematic equivalent circuit diagram of the dielectric waveguide filter illustrated in FIG. 8.

FIG. 10 is a graph illustrating a result of electromagnetic simulation on the dielectric waveguide filter illustrated in FIG. 8.

FIG. 11 is an exploded perspective view of a coupling window of a dielectric waveguide resonator in related art.

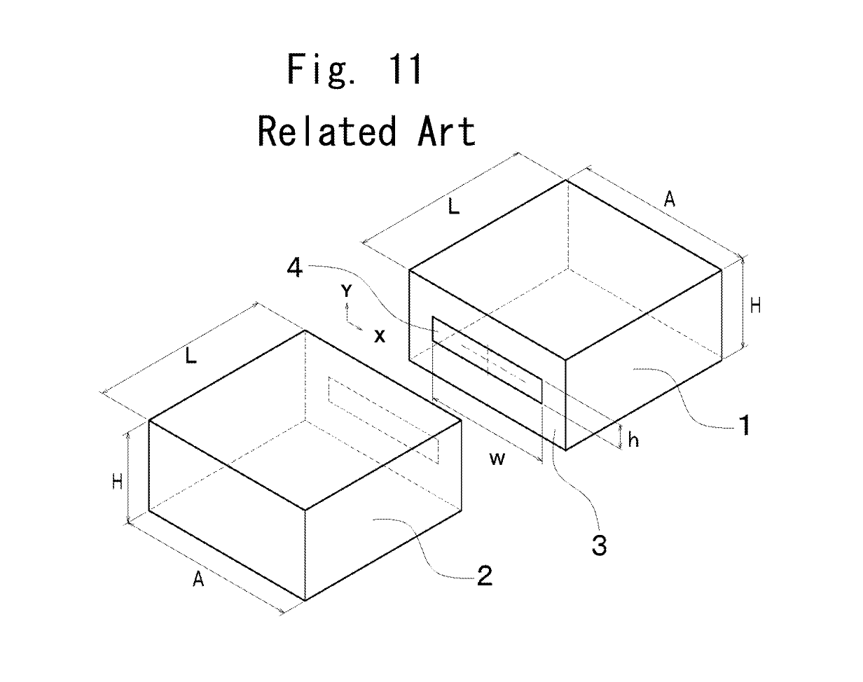

FIG. 12 is a graph illustrating a result of electromagnetic simulation on the dielectric waveguide resonator illustrated in FIG. 11.

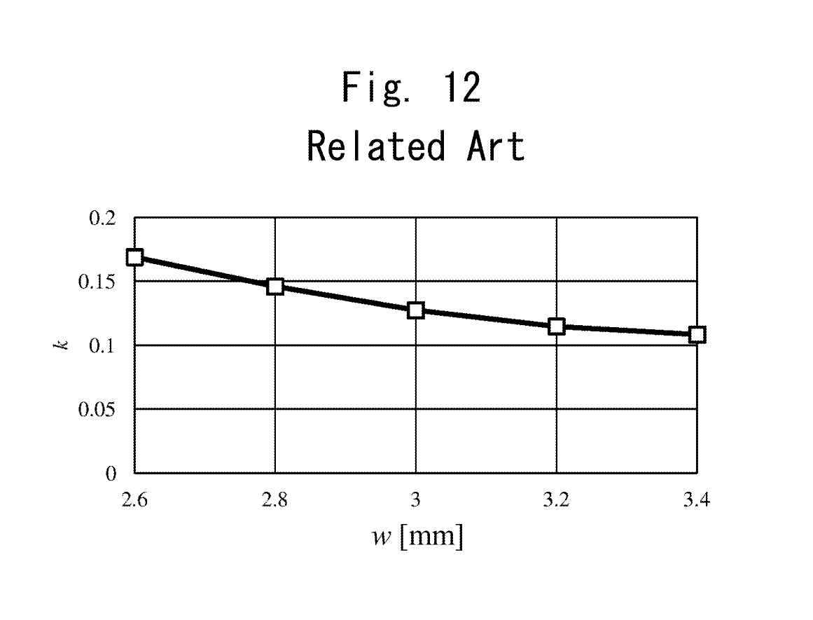

FIG. 13 is a graph illustrating a result of electromagnetic simulation on the dielectric waveguide resonator illustrated in FIG. 11.

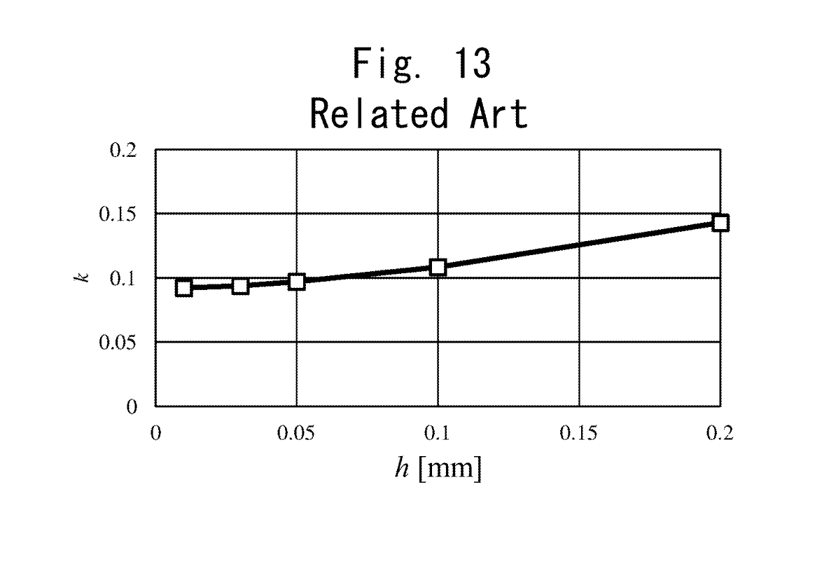

### DETAILED DESCRIPTION

### First Embodiment

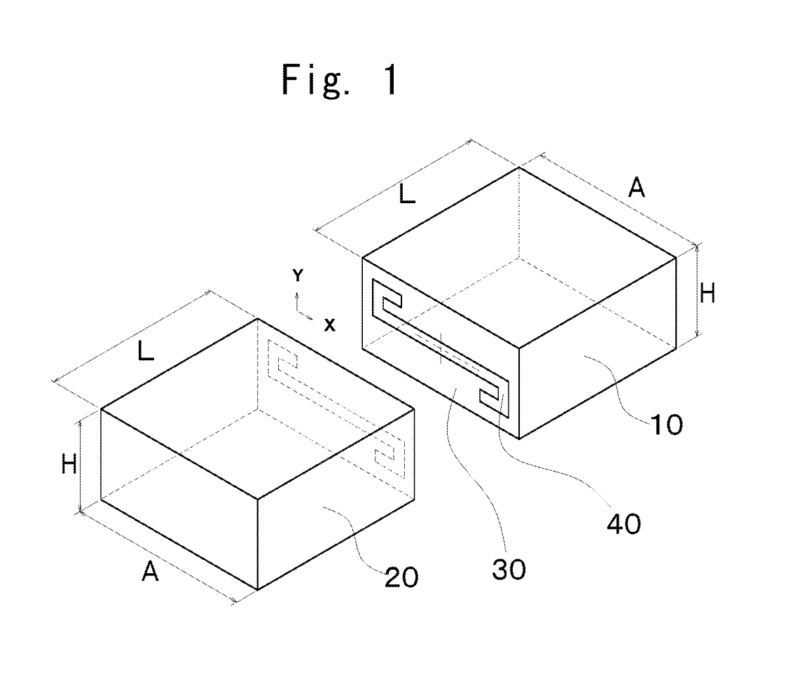

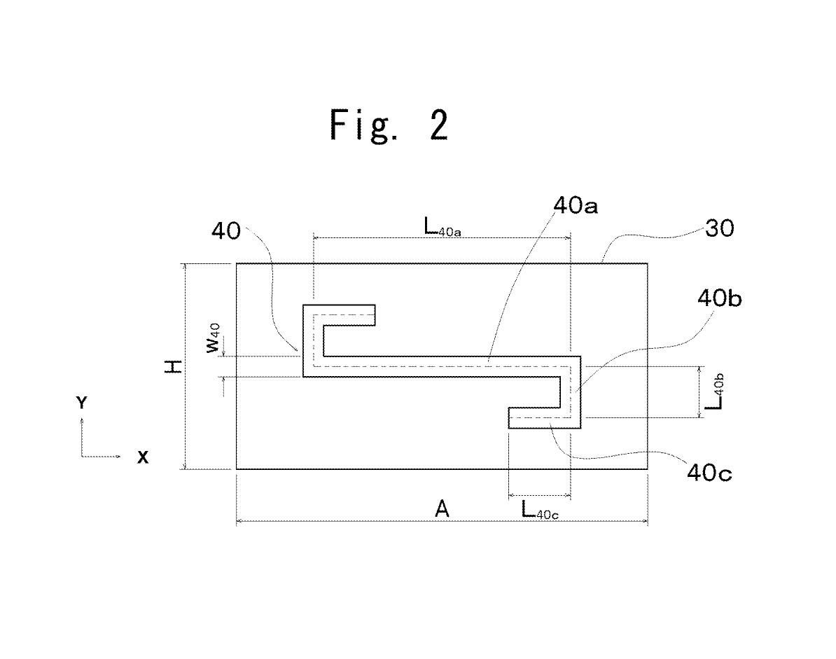

FIG. 1 is an exploded transparent perspective view for describing a coupling window of a dielectric waveguide resonator according to a first embodiment, and FIG. 2 is a plan view for describing this coupling window in detail.

As illustrated in FIG. 1 and FIG. 2, dielectric waveguide resonators 10 and 20, each having a rectangular parallelepiped shape whose outer dimensions are A in width, L in length, and H in height and having a resonant mode of TE101, are aligned along a length direction L. A substantially S-shaped coupling window 40 is formed on a connecting face 30 between the dielectric waveguide resonators 10 and 20.

The coupling window 40 includes a first linear portion 40a extending parallel to a magnetic field direction X, second linear portions 40b extending parallel to an electric field direction Y from both end portions of the first linear portion in directions opposite to each other, and third linear portions 40c extending parallel to the direction X from respective top portions of the second linear portions 40b in directions facing toward each other.

The length of the first linear portion 40a (length in the magnetic field direction X illustrated in FIG. 1) is L₄₀ₐ, the length of the second linear portion 40b (length in the electric field direction Y illustrated in FIG. 1) is L_{40b}, the length of the third linear portion 40c (length in the magnetic field direction X illustrated in FIG. 1) is L_{40c}, and the width of the first to third linear portions 40a, 40b, and 40c is w₄₀.

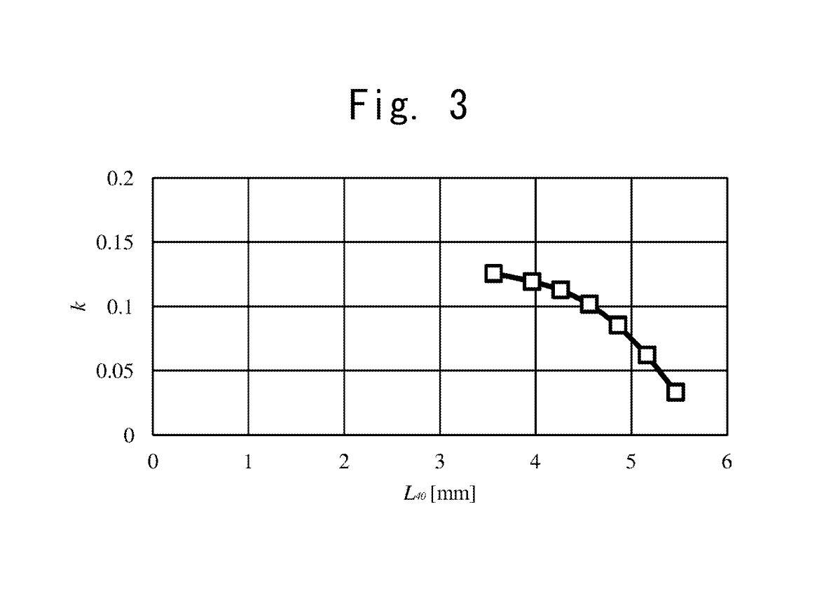

FIG. 3 is a graph illustrating the coupling coefficient k of the dielectric waveguide resonator illustrated in FIG. 1 when width A=3.4 mm, length L=3.8 mm, height H=1.5 mm, L₄₀ₐ=2.8 mm, L_{40b}=1.2 mm, w₄₀=0.3 mm and the total length L₄₀ (=L₄₀ₐ+L_{40b}×2+L_{40c}×2) of the coupling window 40 is varied by adjusting the length of the third linear portion L_{40c} of the coupling window 40.

In FIG. 3, the vertical axis represents the coupling coefficient k, and the horizontal axis represents the total length L₄₀ (mm).

From the result of FIG. 3, it is clear that the coupling window of the dielectric waveguide resonator of the first embodiment enables the coupling coefficient to be reduced to approximately 0.033 despite the fact that the width w₄₀ of the coupling window is 0.3 mm.

### Second Embodiment

In the first embodiment, both end portions of the first linear portion 40a of the coupling window are extended. Alternatively, only one end portion may be extended in the shape of the coupling window.

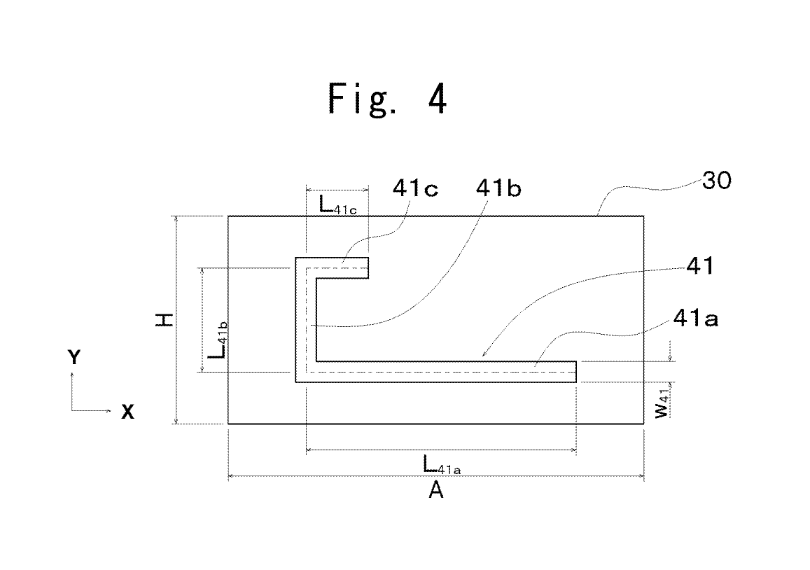

FIG. 4 is a plan view for describing a coupling window of the dielectric waveguide resonator according to a second embodiment. Constituting elements other than the coupling window 41 are the same as those in FIG. 1, and thus, detail descriptions of those constituting elements are omitted here.

On the connecting face 30 between the dielectric waveguide resonators 10 and 20, a substantially J-shaped coupling window 41 illustrated in FIG. 4 is formed.

The coupling window 41 includes a first linear portion 41a extending parallel to the direction X, a second linear portion 41b extending parallel to the direction Y from one end portion of the first linear portion 41a, and a third linear portion 41c extending parallel to the direction X from a top portion of the second linear portion 41b in the same direction as the direction of the first linear portion 41a.

The length of the first linear portion 41a is L₄₁ₐ, the length of the second linear portion 41b is L_{41b}, the length of the third linear portion 41c is L_{41c}, and the width of the first to third linear portions 41a, 41b, and 41c is w₄₁.

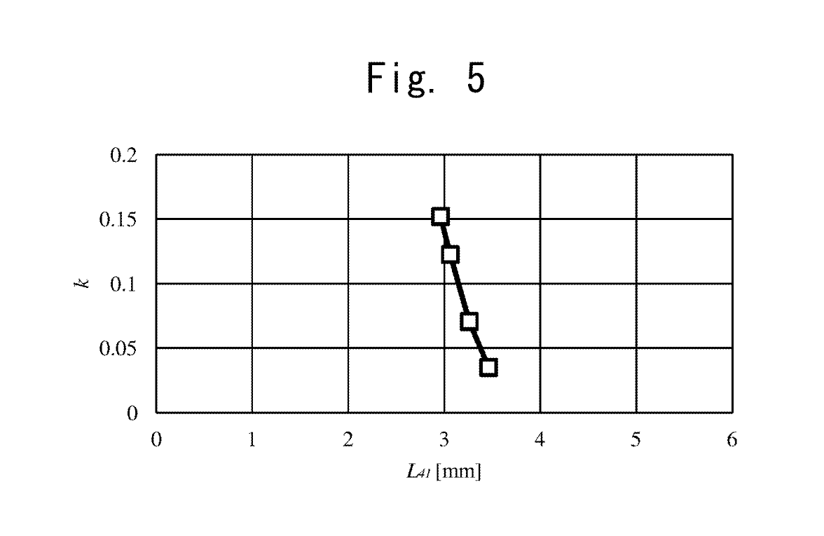

FIG. 5 is a graph illustrating the coupling coefficient k of the dielectric waveguide resonator illustrated in FIG. 4 when L₄₁ₐ=1.5 mm, L_{41b}=0.46 mm, w₄₁=0.3 mm, and the total length L₄₁ (=₄₁ₐ+L_{41b}+L_{41c}) of the coupling window 41 is varied by adjusting the length of the third linear portion L_{41c} of the coupling window 41.

In FIG. 5, the vertical axis represents the coupling coefficient k, and the horizontal axis represents the total length L₄₁ (mm).

From the result of FIG. 5, it is clear that the coupling window of the dielectric waveguide resonator of the second embodiment enables the coupling coefficient to be reduced to approximately 0.035 despite the fact that the width w₄₁ of the coupling window is 0.3 mm.

### Third Embodiment

In the first embodiment, the two end portions of the first linear portion 40a of the coupling window 40 are extended in directions opposite to each other. Alternatively, the two end portions may be extended in the same direction.

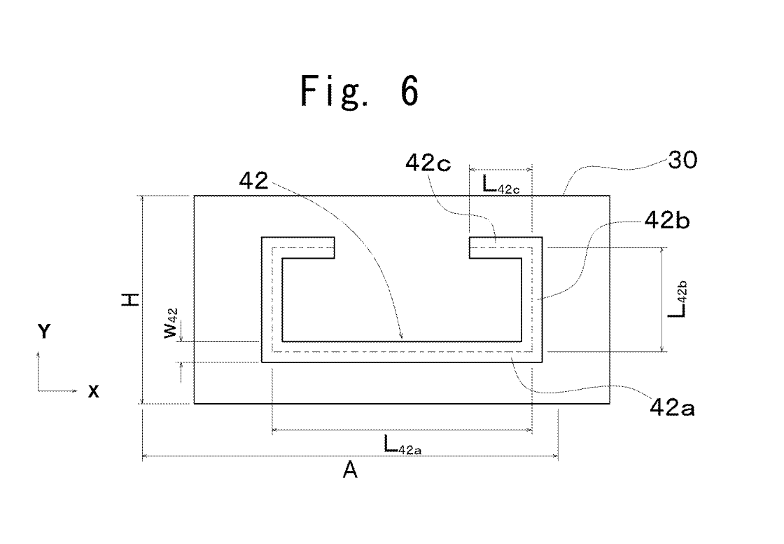

FIG. 6 is a plan view for describing a coupling window of the dielectric waveguide resonator according to a third embodiment in detail. Constituting elements other than the coupling window 42 are the same as those in FIG. 1, and thus, detail descriptions of those constituting elements are omitted here.

On the connecting face 30 between the dielectric waveguide resonators 10 and 20, a substantially C-shaped coupling window 42 is formed.

The coupling window 42 includes a first linear portion 42a extending parallel to the direction X, second linear portions 42b extending parallel to the direction Y from both end portions of the first linear portion and in the same direction to each other, and third linear portions 42c extending parallel to the direction X from respective top portions of the second linear portions 42b in directions facing toward each other.

The length of the first linear portion 42a is L₄₂ₐ, the length of the second linear portion 42b is L_{42b}, the length of the third linear portion 42c is L_{42c}, and the width of the first to third linear portions 42a, 42b, and 42c is w₄₂.

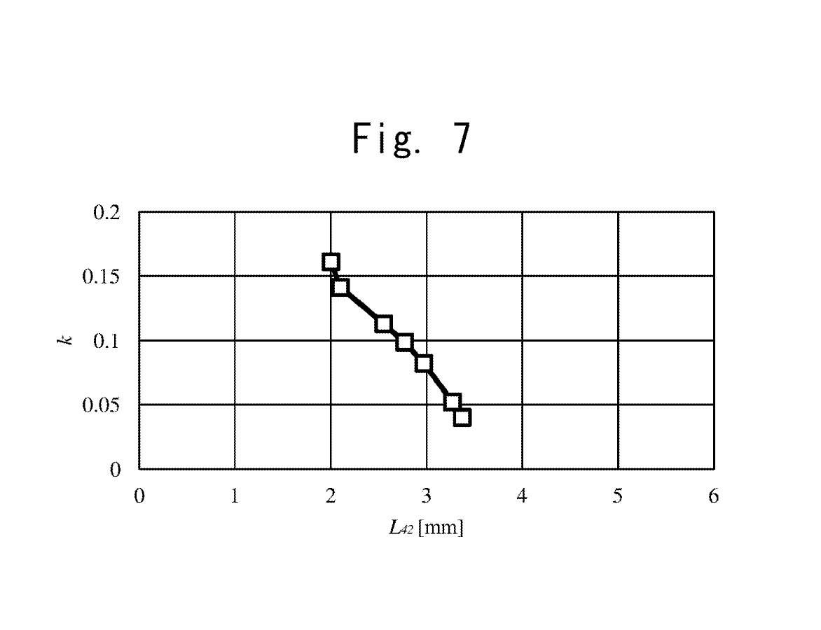

FIG. 7 is a graph illustrating the coupling coefficient k of the dielectric waveguide resonator illustrated in FIG. 6 when L₄₂ₐ=1.6 mm, L_{42b}=0.65 mm, w₄₂=0.3 mm, and the total length L₄₂ (=L₄₂ₐ+L_{42b}×2+L_{42c}×2) of the coupling window 42 is varied by adjusting the length of the third linear portion L_{42c} of the coupling window 42.

In FIG. 7, the vertical axis represents the coupling coefficient k, and the horizontal axis represents the total length L₄₂ (mm).

From the result of FIG. 7, it is clear that the coupling window of the dielectric waveguide resonator of the third embodiment enables the coupling coefficient to be reduced to approximately 0.040 despite the fact that the width w₄₂ of the coupling window is 0.3 mm.

In the first embodiment, the first linear portion 40a is arranged at a center of the connecting face 30 in the height direction H. In the second embodiment and the third embodiment, the first linear portions 41a and 42a are arranged at offset positions on the connecting face 30 in the height direction H. When the position of the coupling window is shifted from the center of the height H, a reducing effect of the coupling coefficient is obtained.

Note that when the total length of the coupling window becomes longer, a resonance may be produced that has an influence on harmonics of the filter. Thus, it may be preferable to have a shorter total length. Accordingly, the second embodiment may be more preferable than the first embodiment, and the third embodiment may be more preferable than the second embodiment.

### Fourth Embodiment

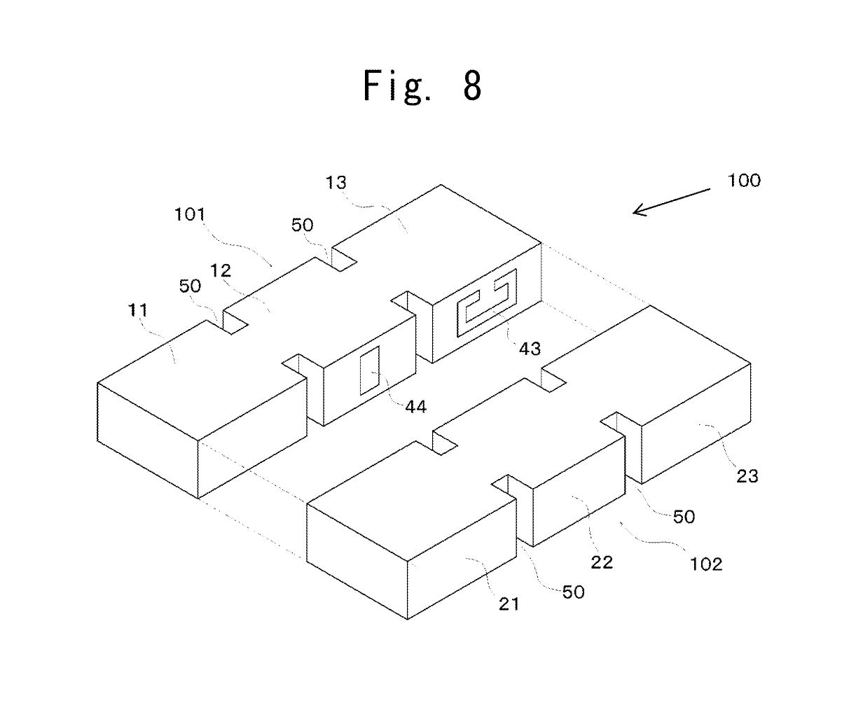

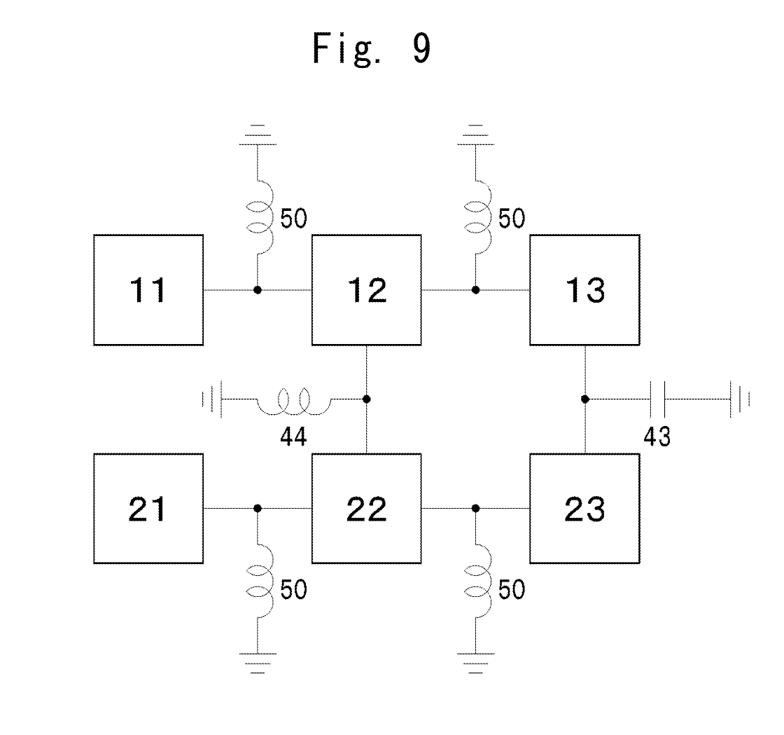

FIG. 8 is an exploded perspective view showing one example of a dielectric waveguide filter employing a coupling structure of the dielectric waveguide resonator of the third embodiment, and FIG. 9 is a schematic equivalent circuit diagram of the example.

As illustrated in FIG. 8 and FIG. 9, a dielectric waveguide filter 100 includes two bar-like dielectric waveguide resonator groups 101 and 102. The dielectric waveguide resonator group 101 and the dielectric waveguide resonator group 102 are each divided by irises 50 in such a way that dielectric waveguide resonators 11, 12, and 13 are formed in the dielectric waveguide resonator group 101, and dielectric waveguide resonators 21, 22, and 23 are formed in the dielectric waveguide resonator group 102.

The dielectric waveguide resonator group 101 and the dielectric waveguide resonator group 102 are arranged in such a way that the dielectric waveguide resonator 11 is adjacent to the dielectric waveguide resonator 21, the dielectric waveguide resonator 12 is adjacent to the dielectric waveguide resonator 22, and the dielectric waveguide resonator 13 is adjacent to the dielectric waveguide resonator 23.

A coupling window 44 is formed between the dielectric waveguide resonator 12 and the dielectric waveguide resonator 22, and a C-shaped coupling window 43 of the third embodiment is formed between the dielectric waveguide resonator 13 and the dielectric waveguide resonator 23.

The dielectric waveguide filter 100 is a dielectric waveguide filter in which a route of the dielectric waveguide resonators 11→12→13→23→22→21 is a main path, a route of the dielectric waveguide resonators 12→22 is a jump coupling, the irises 50 are inductive coupling windows, and the coupling window 43 is a capacitive coupling window.

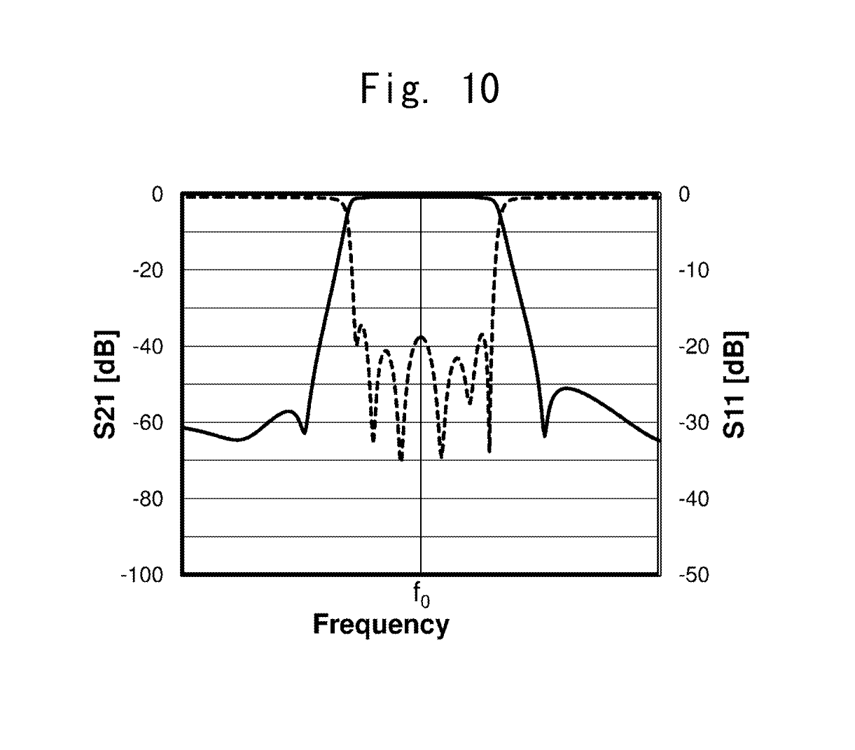

FIG. 10 is a graph illustrating electric characteristics of a dielectric waveguide filter according to the fourth embodiment illustrated in FIG. 8. Here, the solid line represents insertion loss S21 (in dB), the dotted line represents return loss S11 (in dB), and the horizontal axis represents frequency. From the result of FIG. 10, it is clear that the coupling window 43 is a capacitive coupling window since there is an attenuation pole in the dielectric waveguide filter 100.

As described above, the total length of the coupling window can be made larger than the width of the resonator by bending a top end direction of the coupling window within the connecting face in such a way as to form, for example, a substantially S-shape, a substantially J-shape, or a substantially C-shape. In this case, the coupling coefficient can be substantially reduced compared with a case where a simple linear-shaped coupling window is used. As a result, a coupling window having a coupling coefficient suitable for designing a dielectric waveguide filter and the like can be provided. Further, coupling windows of dielectric waveguide resonators of the present disclosure have higher power resistance characteristics, and are suitable for dielectric waveguide filters using jump coupling.

The present disclosure is not limited to the foregoing exemplary embodiments. Numerous variations, whether explicitly provided for by the specification or implied by the specification or not, may be implemented.

What is claimed is:

1. A coupling window for coupling two dielectric waveguide resonators that each resonate at a TE mode and include a rectangular parallelepiped dielectric body with a conducting film coating an outer surface of the rectangular parallelepiped dielectric body, the coupling window comprising:
a first linear portion extending parallel to a first direction;
a second linear portion extending from an end portion of the first linear portion, the second linear portion extending parallel to a second direction that is orthogonal to the first direction; and
a third linear portion extending from an end portion of the second linear portion, the third linear portion extending parallel to the first direction.

2. The coupling window according to claim 1, further comprising:
a fourth linear portion extending from another end portion of the first linear portion, the fourth linear portion extending parallel to the second direction; and
a fifth linear portion extending from an end portion of the fourth linear portion, the fifth linear portion extending parallel to the first direction.

3. The coupling window according to claim 2, wherein the second linear portion and the fourth linear portion extend from the first linear portion in the opposite directions.

4. The coupling window according to claim 2, wherein the second linear portion and the fourth linear portion extend from the first linear portion in the same direction.

5. The coupling window according to claim 2, wherein:
the third linear portion extends from the second linear portion toward the fifth linear portion; and
the fifth linear portion extends from the fourth linear portion toward the third linear portion.

6. The coupling window according to claim 1, wherein the first direction corresponds to a magnetic field direction and the second direction corresponds to an electric field direction.

7. The coupling window according to claim 1, wherein the coupling window is provided on a connecting face of one of the two dielectric waveguide resonators such that the first linear portion is positioned at a center of the connecting face along a height direction of the connecting face.

8. The coupling window according to claim 1, wherein the coupling window is provided on a connecting face of one of the two dielectric waveguide resonators such that the first linear portion is offset from a center of the connecting face along a height direction of the connecting face.

9. The coupling window according to claim 1, wherein the coupling window has a substantially J-shape.

10. The coupling window according to claim 1, wherein the coupling window has a substantially S-shape.

11. The coupling window according to claim 1, wherein the coupling window has a substantially C-shape.

12. A dielectric waveguide filter having the coupling window according to claim 1.

13. A resonator assembly comprising:
two dielectric waveguide resonators that each resonate at a TE mode and include a rectangular parallelepiped dielectric body with a conducting film coating an outer surface of the rectangular parallelepiped dielectric body; and
a coupling window coupling the two dielectric waveguide resonators, the coupling window including:
a first linear portion extending parallel to a first direction,
a second linear portion extending from an end portion of the first linear portion, the second linear portion extending parallel to a second direction that is orthogonal to the first direction, and
a third linear portion extending from an end portion of the second linear portion, the third linear portion extending parallel to the first direction.

14. The resonator assembly according to claim 13, wherein the coupling window further comprises:
a fourth linear portion extending from another end portion of the first linear portion, the fourth linear portion extending parallel to the second direction; and
a fifth linear portion extending from an end portion of the fourth linear portion, the fifth linear portion extending parallel to the first direction.

15. The resonator assembly according to claim 14, wherein the second linear portion and the fourth linear portion extend from the first linear portion in the opposite directions.

16. The resonator assembly according to claim 14, wherein the second linear portion and the fourth linear portion extend from the first linear portion in the same direction.

17. The resonator assembly according to claim 14, wherein:
the third linear portion extends from the second linear portion toward the fifth linear portion; and
the fifth linear portion extends from the fourth linear portion toward the third linear portion.

18. The resonator assembly according to claim 13, wherein the first direction corresponds to a magnetic field direction and the second direction corresponds to an electric field direction.

19. The resonator assembly according to claim 13, wherein the coupling window is provided on a connecting face of one of the two dielectric waveguide resonators such that the first linear portion is positioned at a center of the connecting face along a height direction of the connecting face.

20. The resonator assembly according to claim 13, wherein the coupling window is provided on a connecting face of one of the two dielectric waveguide resonators such that the first linear portion is offset from a center of the connecting face along a height direction of the connecting face.
